(19) United States
(12) Patent Application Publication
(10) Pub. No.: US 2008/0274721 A1
(43) Pub. Date: Nov. 6, 2008

(54) Interoperable System and Method for Managing Multiple Geolocatable Services

(76) Inventor: Jonathan Stagnetto, Gibraltar (GB)

Correspondence Address: LADAS & PARRY LLP, 224 SOUTH MICHIGAN AVENUE, SUITE 1600, CHICAGO, IL, 60604, US

(21) Appl. No.: 11/997,426

(22) PCT Filed: Aug. 2, 2006
(86) PCT No.: PCT/EP2006/007647

§ 371 Date: Jan. 31, 2008

(30) Foreign Application Priority Data
Aug. 2, 2005 (EP) PCT/EP05/008331

(51) Int. Cl. H04Q 7/22

(52) U.S. Cl. 455/414.2

(57) ABSTRACT

The invention relates to an interoperable system and method for managing geolocatable multiple services. The invention is particularly for use in toll transport services. The system comprises a database and a module for managing this database. The database contains identification information of a number of users, a number of services of which the location of these services, and a number of suppliers as well as information for authorizing access of the users to one or more services. In addition, the management module comprises a submodule for receiving the location and identification information of the user transmitted by the transmitting means, a submodule for comparing location information of the user with the location information of services, and a submodule for monitoring the authorization of access of the user to a service among the number of services offered by the supplier among the number of suppliers.

The subject of this present invention is a system and a method for the interoperable management of multiple geolocatable services. It finds its application, in particular but not uniquely, in the field of transport toll services.

More generally, this present invention concerns a particular organisation that allows users to choose, from among several service providers, the service or services that they wish to purchase, where these service or services are located in a given place. It can consist, for example, of the use of a road or a motorway, the use of a vehicle park, the benefits of a vehicle insurance policy, the use of a train, etc.

The organisation allows the users to gain access to these services, with no geographical limit, and to use them, with monitoring for the purpose of checking on their situation in relation to the service or services purchased, without the need to be in possession, at any given moment, of a specific token or coupon for each service purchased, like a ticket for instance, and without slowing down the access flow of the users to the services concerned.

The organisation also allows the service providers to propose services or combinations of services, even differing in their nature, specifically adapted to each user, and charges that are capable of changing dynamically and in real time.

Finally, the organisation allows states and regional authorities to be in possession, in real time, of information that allows them to dynamically manage the application of certain aspects of their social, environmental, regional development and other policies.

At present, the purchase or the use of many services is generally characterised by the presentation of a physical token such as a ticket that is specific to each service, or even to each service provider, for a given service.

When this token is not secured however, it can be copied or modified. A fraud can then develop, to the prejudice of the service provider, and indeed of the users, who will have to bear the loss involved.

If the token is secured however, any alteration of the latter can oblige the user to present some evidence of purchase of the token during checks, or even to acquire a new token in the worst case.

When, as in the case of road tolling, it is necessary to allow a maximum of users to gain easy access to the services around the clock and 365 days a year, the network established to provide the token becomes very costly, to the extent that the specific character of the token to a service, or to a service provider, does not allow mutualisation of the infrastructures or their maintenance.

Furthermore, when it is necessary to recover the token at predetermined points of a network, long queues can form, such as at road toll stations or at cinema box offices for example.

When poorly managed, these queues give rise to dissatisfaction amongst the users who, in extreme cases, cease to use the service or who, exasperated, sometimes display aggressive attitudes toward the staff, damage the ticket dispensing machines, and reduce the attention level of the members of staff and their productivity. These queues slow down or prevent access to the proposed services and limit economic performance.

When well managed however, these queues are very costly since they require an increase in the number of access points. In the example of a motorway network, it is thus necessary to provide a toll barrier at each entry point, and also, in most cases, at each exit from a motorway network. In the example of a vehicle park, it is necessary to provide several vehicle park paying points.

Furthermore, when the token is available at predetermined points of a network, supplies to each point must be sufficient in number and in quality, which necessitates very efficient management of the token stocks.

Moreover, when payment of the charge for the services is effected at predetermined points in a network, then the risk of embezzlement of the revenue, by fraudulent action or by theft for example, calls for securing of all points in the network as well as regular cash collections.

When the tokens themselves represent a market value, as is the case of tokens relating to the charges or rights drawn from the Treasury, or tickets for shows for example, this level of security has to be reinforced.

When the issuer of the token sells a number of tokens that is greater than the accommodation capacity of a service (overbooking), it can happen that legitimate customers are barred from the service or event. In this case, the financial, legal or commercial compensation paid will reduce the profitability anticipated by the service provider.

Also, when a physical token is issued, no dynamic management of the charges is possible, nor are any alternative offers to substitute one service by another (for example: in the event of saturation of a motorway lane, free use of a vehicle park at certain times). Regulation of access to the services by modulation of the charges cannot be envisaged.

It is thus difficult, or even impossible to take account of variable parameters whose frequency of variation can be high (such as modulation of the charges for the right to travel via a motorway according to the instantaneous density of the traffic for example).

Moreover, passage from one charging formula to another is not very easy, and obliges the user to go to one of the dispensing points in the network, or even, in certain cases, to the original purchase point, in order to effect the change.

Finally, validity checks on the tokens are fastidious, especially when the number of formulas is large and the customers are geographically scattered.

We are already familiar with many organizations which aim at improving the purchase of services by the use of dispensing machines, telephone-call reception platforms, Internet platforms allowing registration on line, or indeed platforms combining several of these methods. In one way or another, they all amount to the issuing of a specific token, and they all have the drawbacks described previously.

We also know, for example, from documents U.S. Pat. No. 6,744,843 and US 2004/167861, several organisations that are attempting to facilitate access to the services or to control or monitor entry to and exit from the services. These involve physical people or dispensing machines positioned at predetermined locations, activated by data present on a medium, transmitted by a communicating system or by a recognition system (biometric reader, magnetic tape reader, registration plate reader, etc.).

All these organisations are unsuitable for services with many access points, firstly because of time required to set them up and use them, secondly because of the magnitude of the infrastructures that they require, and finally because of the cost, both of the resulting investment and maintenance. Moreover, the organisations that require the physical presence of people can be brought to a standstill by work stoppages by the staff, and those relying on dispensing machines use systems that are specific to a service and, more generally, to a single service provider.

We are also familiar with many organisations that aim at facilitating the payment process. These all make use of payment media, either directly (insertion into a reader), or indirectly (transmission of the information present on the medium). They all experience similar difficulties, which are further exacerbated when the user is unable to consult or possess a detailed invoice for the services consumed.

Finally, we currently do not know of any organisation that allows service providers offering identical or different services to propose services or combinations of services that are specifically designed for each user, or any organisation that allows service providers to change their charges in real time and dynamically in accordance with parameters from within or external to the services or to the combinations of services used or subscribed to by the user.

Neither do we know of any organisation that allows states and regional authorities to be in possession, in real time, of information that allows them to dynamically manage the application of their public policies.

By decoupling the token from the underlying service, this present invention therefore allows simultaneous management of the different types of services proposed, possibly by several service providers in each case, to pass at any moment and in real time from one charging formula to another, and to take advantage of this change with no down time as a function of the services chosen, to bill these services, even when their price changes in accordance with parameters that vary constantly, by unitary service or by service or in a grouped manner with a classification that may be analytical or not, to compensate for the crossover payments between the service providers and to provide each of these, and also third parties where appropriate, with relevant information necessary for their controls, and for the technical, financial and commercial management of their services or the monitoring of their policies.

The organisation of the invention is particularly well suited to transportation services (road tolling, insurance per kilometre, rail freight, etc.), and in general to all services associated with locations to which access is controlled (theatres, museums, amusement parks, etc.) and to all “machine to machine” (M2M) services.

The organisation of the invention is also well suited to the grouping of the requests to purchase from users wishing to obtain from service providers the most advantageous services and/or products on the market.

This present invention therefore aims at remedying the aforementioned drawbacks, by virtue of a meta organisation that is representative of the different existing methods and means of telecommunication, detection, distribution, management, payment, centralisation and compensation, open simultaneously to several service providers and to several different types of services which, because it decouples the token from the underlying service, no longer requires one to be in possession, at any given moment, of a specific token for the service purchased (e.g. a ticket, etc.).

It therefore allows mutualisation of the means used in a “Virtual Business Model” (VBM) unlike past organisations, and adaptation of the control/monitoring requirements in both space and time.

The proposed organisation is composed of a platform that serves as an interface to the users, that can be contacted around the clock and 365 days a year by all the methods and means of telecommunication currently available on the market (fixed and mobile telephony, internet, e-mail, facsimile, etc.) and that allows the incorporation of future communication means. It allows users to register in a non-specific manner to a given service, to purchase a variety of services from miscellaneous service providers, to manage their choice of services and their characteristics (modification of the charging formula, etc.) in real time, and to be in possession, in real time, on the medium of their choice (telephone, personal digital assistant, e-mail, dedicated Internet site, etc.), of detailed status information on the services chosen and/or used.

The proposed organisation is also composed of a consistent set of systems allowing the processing of locations obtained from a positioning means (such as GPS, triangulation, location beacons, etc.) with a view to obtaining payment for the service used and the monitoring associated with the handling of any fraud.

Finally, the proposed organisation is composed of a database in which the information relating to the subscribers and to the actual users of the service or services are recorded, together with that coming from the systems employed to handle the locations and the control/monitoring systems, information applicable to each service and each service provider (pricing formulae, charge modulation parameters, etc.), all of the procedures and elements allowing the use of the database for purposes of control or monitoring (of the users, of the organisation management, of the service providers, of third parties, etc.), of calculation, of centralisation, of billing and payment, of payment of the crossover debts between the different service providers, and in general, all the information necessary for operation, maintenance and performance measurement of the organisation by the controller or manager and/or third parties.

The database is used in particular to simultaneously manage several service providers and different service types with their different specificities, including services that are regulated dynamically from variable parameters, even external to the services used or subscribed to, whose number and the frequency are not limited.

All the elements making up this organisation are built into a telecommunication network that allows the exchange of information, in particular between the users and the proposed organisation, between the different elements constituting the proposed organisation, between these elements and any devices necessary for their operation, for their maintenance and for performance measurement of the proposed organisation, between the proposed organisation and any devices necessary to determine the level of the parameters for regulation of the services, between the proposed organisation and the arrangements for monitoring and punishing of any infringements associated with the services, and between the proposed organisation and third parties.

The proposed organisation therefore provides the service providers and the user with a significant economic advantage in relation to the other existing organisations, by rendering the services interoperable, by mutualising the means for management and billing of the different services supplied by the different service providers, while also improving productivity and significantly reducing all the costs relating to infrastructure, operation, maintenance, and control or monitoring. This advantage is all the more significant because of the fact that the proposed organisation is not limited to a given number of service providers or of services, or to a particular geographical area.

By centralising all of the services consumed, the proposed organisation lightens the accounting effort for the services used, by giving the option to the user to be in receipt of a single bill or of a consolidated bill with the level of analytical detail specified dynamically by the user concerned. It thus facilitates the checking and management processes of users.

By centralising all payment incidents, the proposed organisation also gives greater security to the service providers regarding the solvency of the users and can constitute a dynamic tool for the prevention of payment incidents, since a user who does not pay for one of the services loses the ability to use all the other services available.

More generally, according to a first aspect, the invention therefore relates to a system for the interoperable management of multiple geolocatable services proposed by service providers and accessible, by tolling, to users equipped with a transmission means for regular or intermittent transmission of location and identification data.

The system includes a database, and a module for managing this database.

In a characteristic manner, the database includes data for the identification of a multiplicity of users, data for the identification of a multiplicity of services including the location of these services, and data for the identification of a multiplicity of service providers, as well as of data for the authorisation of access by users to one or more of the said services.

Furthermore, the management module includes a sub-module to receive the location and identification data of the user that is sent by the transmission means.

The management module also includes a sub-module for comparing the location data of the user with the location data of the services.

The management module finally includes a sub-module to control the authorisation of access by the user to one service from among the multiplicity of services proposed by the service provider from among the multiplicity of service providers.

Thus the system of the invention allows the control of access by the users to multiple services, with no physical means of access detection positioned close to the services and/or at several points in the network constituting the service.

The system of the invention therefore in particular solves the problems, encountered in the prior art, of incompatibility of the terminals or the means for detecting access to several different services proposed by several different service providers, and of saturation of the access to the various services due to the need to pass close to a given terminal or a given means of detection.

The system of the invention also overcomes all the difficulties associated with the interoperability between the service providers of a given service, without any geographical limit.

In a first variant, the means for regular or intermittent transmission of the location and identification data of the user is of the mobile telephone and/or personal digital assistant type.

In another variant, possibly in combination with the preceding one, with at least one of the services from among the multiplicity of services being a toll service, the management module includes a sub-module to calculate the cost of the access by the given user to the given service.

In yet another variant, possibly in combination with one or more of the preceding ones, the system includes the means for control and interdiction of access by the user to the service, which can be activated prior to, and/or during, and/or after using the service.

The means for control and interdiction of access by the user to the service, which can be activated prior to, and/or during, and/or after the use of the service, preferably include a means of intervention, whether located close to the user or not, and the management module includes a sub-module for the transmission of interdiction data to the means of intervention.

In yet another variant, possibly in combination with one or more of the preceding ones, the system includes a user interface that allows a user to subscribe, in the database, to a given service of a given service provider, and to update and receive his or her personal data and those relating to the given service and to the given service provider.

In yet another variant, possibly in combination with one or more of the preceding ones, the system includes a service provider interface that allows a service provider to subscribe, in the database, for the provision of a given service, and to update and receive data relating to this given service.

In yet another variant, possibly in combination with one or more of the preceding ones, with the user able, during a given period, to consume one or more given services made available by one or more different service providers, the management module includes a sub-module for centralising the services consumed, allowing consolidation on a single bill of all or part of the services consumed during the given period.

In yet another variant, possibly in combination with one or more of the preceding ones, the management module includes a sub-module for payment of the crossover debts between several service providers.

In yet another variant, possibly in combination with one or more of the preceding ones, the management module includes a sub-module for centralising any payment incidents.

In yet another variant, possibly in combination with one or more of the preceding ones, the management module includes a sub-module for centralising any infringements and any punishments, in particular allowing the prevention and management of repeat infringement.

In yet another variant, possibly in combination with one or more of the preceding ones, the management module includes a means for time and date stamping of access by the user to the service of the service provider and/or of the length of use of this given service.

According to a second aspect, the invention also relates to a method for the interoperable management of multiple geolocatable services proposed by service providers and accessible to users by tolling.

In a characteristic manner, the method includes a stage of transmission, by a regular or intermittent transmission means, of the location and identification data of a user.

It also includes a stage for receiving location and identification data of the user, by a means for controlling access by a user to a service.

It also includes a stage for comparing the location data of the user with the location data of the services, stored in a database, where this database also includes data for the identification of a multiplicity of users, and of a multiplicity of service providers, as well as data for the authorisation of access by the users to one or more of the services.

Finally, in the case in which the location data of the user coincide with the location data of a service, the method includes a stage to control the authorisation of access of the user to the service.

In a first variant, the method includes a stage for billing of the user for its access to the service of the service provider and/or for the length of use of this service.

In another variant, possibly in combination with the preceding one, the method includes a stage of observation of infringements, when the stage to control the authorisation of access by the user to the service shows that the user is not registered for the service in the database or that the right of the user to gain access to the service is invalid.

Other characteristics and advantages of the invention will appear more clearly and more completely on reading the description that follows of the preferred implementation variants of the system and of the method, which are given by way of non-limiting examples and with reference to the following appended drawing:

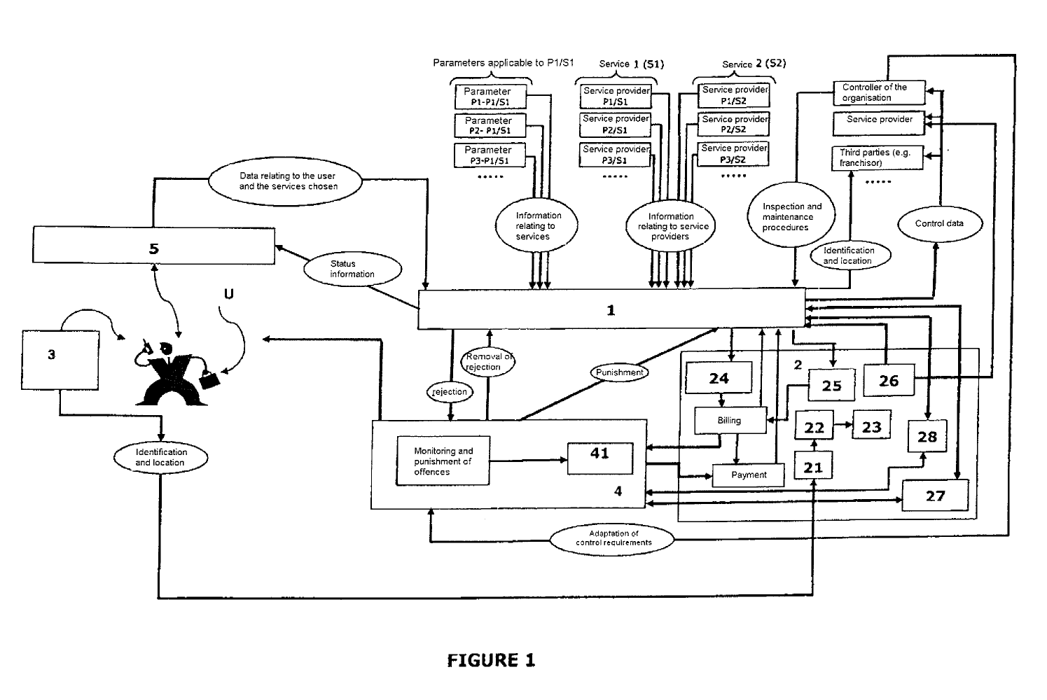

FIG. 1 schematically represents one implementation variant of the system of the invention.

In fact, the invention will be understood more clearly on reading the schematic description that follows in relation to FIG. 1, which is provided only by way of a guide, and which represents an example of an organisation that allows a user U to gain access with his vehicle to a section of road that is subject to the payment of a toll, on which he has the benefit of an assistance service that enables him to be informed, on his personal digital assistant for example, or on his on-board computer, or indeed on his mobile telephone 3, on the state of the traffic on the roadway in question, and then of parking his vehicle in a vehicle park in order to take a train.

These devices, such as a personal digital assistant or a vehicle computer, or indeed a mobile telephone 3, are also equipped with a positioning system, of the GPS type for example, so that they also have a function of regular or intermittent transmission of the location and identification data of the user U.

The system therefore includes a database 1, and a management module 2 for this database 1.

In particular, the database 1 includes information on the identification of users U, services S and service providers P, as well as information on the authorisation of access by the users U to one or more services S.

In particular, the service identification data S include the geographical service location data S.

The management module 2 includes a sub-module 21 to receive the location and identification data of the user U transmitted by a transmission medium, such as the mobile telephone 3.

The management module 2 also includes a sub-module 22 for comparing the location data of the user U with the location data of the services S stored in the database 1.

The management module 2 again includes a sub-module 23 to control the authorisation of access by the user U to a service S, in accordance with the identification data that are transmitted by the transmission medium, such as the mobile telephone 3, and with the identification and authorisation data present in the database 1.

In the case where the transmission medium includes a mobile telephone 3, then the identification data of the user U can be his mobile telephone number.

The management module 2 can include a sub-module 24 to calculate the cost of access by the user U to the service S or of his consumption, which will be explained in greater detail in relation to the example of use of the system presented below.

Where appropriate, the system includes means for control and interdiction 4 of access by the user U to the service S which themselves include a means 41 of intervention, to locally to the user U or not, and that will also be explained in greater detail in relation to the example of use of the system presented below. These means of control and interdiction 4 can be activated prior to and/or during and/or after the use of the service.

In a first stage, and if it is his first contact with the platform or interface 5, the user U, whatever the geographical position at which he is located, contacts this platform or interface 5 by the means of his choice of medium (Internet site, fixed or mobile telephone, e-mail, etc., for example), in order to communicate the information to establish his identification and position (his mobile telephone number, for example) and/or to identify and position of the vehicle used (its license plate number or registration number, the references to his positioning and transmission device of the positions for example).

In the case of road tolling, there is no need to specify an itinerary beforehand. The user U is detected automatically on switching on of the communication device 3.

In the case of the assistance service, no confirmation is necessary, and this service will also be established on switching on the communication device 3.

For the parking service, here again everything is automated on switching on the communication device 3.

For the train, U must indicate, to the platform or interface 5, the train that he wishes to take (time and destination). U can take advantage of decision-making support services if, for example, he wishes to take advantage of the best fares for a given destination or simply to ascertain all the train times for the destination indicated.

U also transmits to the platform or interface 6 the bank data that enables payment for the service purchased or consumed and the data relating to the medium chosen (his personal digital assistant for example).

Naturally however, if U has previously already transmitted these general data to the platform or interface 6, then he only has to indicate the specific information concerned, here the data relating to the train chosen.

During the presence of U in the section, the traffic information service transmits, to the personal digital assistant or the mobile telephone 3 of U for example, the data concerning the road section subject to payment of the toll.

U is able to park his vehicle in the vehicle park without further formality, and the positioning systems associated with the communication device 3 transmits his date of entry and of exit.

Naturally however, no stopping is necessary at the entrance to the vehicle park, thereby rendering the road network and the access to and exit from the vehicle park very fluid.

When U arrives at the station, there is no need to stand in line at the ticket window since there is no need for a ticket. U receives, on his personal digital assistant or on his laptop 3 the seat that is assigned to him. In parallel, the ticket inspector receives details of all the seats assigned, on his personal digital assistant for example.

Fixed or mobile checking devices are used to recognise U's telephone number, the license plate of his vehicle, etc. These checking devices will be placed at the access points to the services (entry to and exit from the vehicle park, access to and egress from the train, etc.) and/or in a random manner throughout the infrastructure supporting the services (the road system for example)

If U's vehicle or U himself is not registered in the database 1 for the service S used (use of the road section subject to payment of the toll, the train, etc., for example) or if his right of access to the service S is not valid (payment out of date, etc., for example), then on recognition of his registration plate or mobile telephone number 3, a signal is transmitted to the management module 2 of the database 1. The latter transmits the information to the means 4 for monitoring and punishing infringements associated with the service S (the security police or a special brigade for example) in order to cancel or confirm the infringement.

In order to prevent repeat offending, the user U who has been punished for a infringement can be recorded in the database 1 in a infringements and punishments register, with as a consequence for the user U the inability to gain access to the service concerned, and/or possibly to other services, until full regularisation of his situation has been effected.

Depending on the time when the service is used, the database 1 selects the corresponding charge, taking account where appropriate of the parameters for modulation of the charge (the level of atmospheric ozone, the period of high frequentation for the train, etc.) and transmits these data to the calculation sub-module 24, that for billing and payment, and possibly that for compensation 26, which determine the amount to be paid, prepare the detailed bill, process payment of the service consumed, and transmit these various elements to the database 1, in particular with a view to making these elements of information available to U on the medium chosen (his personal digital assistant for example).

The management module 2 can also contain a sub-module 27 for centralising the payment incidents, in particular to monitor failure to pay. It can also contain a sub-module 28 for centralising infringements and punishments, in particular allowing the prevention and handling of repeat offending, as well as a sub-module 25 for centralising the services consumed, allowing consolidation in a single bill of all or part of the services consumed during the given period.

If U cannot or does not want to be located, he is able to subscribe only to the fixed-charge services. However he must register in the database 1 and provide his identifier and the identifier of his vehicle or of the communication media that he uses in order to access the services available.

At any time, U is able to contact the platform or interface 5 in order to change the wanted services, such as changing from a daily fixed payment to a charge per kilometre for road tolling for example.

Though it is easy to see all of the advantages to the user U, these are just as valuable to all other involved (service providers P, controller of the organisation, third parties, etc.) who are able to optimise their offers in real time to meet the real requirements of the users, and at lower cost throughout the operational chain.

It is finally recalled that all of the foregoing description is given by way of an example, and does not limit the invention in any way.

In particular, the organisation of the different modules and sub-modules included in the system of the invention and represented in FIG. 1, is given in a functional representation form. It therefore does not limit the invention, so that the different sub-modules represented in FIG. 1, functionally incorporated into one module, can all just as easily be placed physically or logically outside of this module. Likewise, two modules or sub-modules represented as functionally separate in FIG. 1 could just as well be integrated physically or logically.

In addition, the use of a mobile telephone or indeed of a personal digital assistant as devices 3 for transmission of the location and identification data of the user U, obviously does not limit the invention. Any telecommunications transmission medium used in voice and/or data mode, is suitable, in particular including transmission media of the telephone, wi-fi, wimax, or satellite type, etc.

1. A system for the interoperable management of multiple geolocatable services (S) proposed by service providers (P) and accessible, by tolling, to users (U) equipped with a transmission means (3) for regular or intermittent transmission of user location and identification data, including a database (1) and a management module (2) for the said database (1), characterised in that
the said database (1) includes identification data for identification of a multiplicity of users (U), of a multiplicity of services (S), including the location of the said services (S), and of a multiplicity of service providers (P), as well as access authorisation data for authorisation of access by the said users (U) to one or more of the said services (S),
the said management module (2) includes:
i. a sub-module (21) for receiving the said identification and location data of said user (U), transmitted by the said transmission means (3),
ii. a sub-module (22) for comparison of the said location data of the said user (U) with the said location data of the said services (S),
iii. a sub-module (23) to control the authorisation of access by the said user (U) to a service (S) from among the said multiplicity of services proposed by the said service provider (P) from among the said multiplicity of service providers.

2. A system according to claim 2, characterised in that the transmission means (3) for regular or intermittent transmission of user location and identification data is of the mobile telephone type.

3. A system according to either of claims 1 and 2, in which at least one of the services from among the multiplicity of services is a toll service, characterised in that the management module (2) includes a sub-module (24) to calculate the cost of access by the given user (U) to the given service (S).

4. A system according to any one of claims 1 to 3, characterised in that it includes control means (4) for control and interdiction of access by the user (U) to the service (S), which can be activated prior to and/or during and/or after the use of the service (S).

5. A system according to claim 4, characterised in that the control means (4) for control and interdiction of access by the user (U) to the service (S), which can be activated prior to and/or during and/or after the use of the service (S), include a means (41) of intervention, whether located close to the user or not (U), and the management module (2) includes a sub-module for the transmission of an interdiction data to the means (41) of intervention.

6. A system according to any one of claims 1 to 5, characterised in that it includes a user interface (5) that allows a user (U) to subscribe, in the database (1), to a given service (S) of a given service provider (P), to update and receive his personal data and those relating to the said given service (S) and to the said given service provider (P).

7. A system according to any one of claims 1 to 6, characterised in that it includes a service provider interface that allows a service provider (P) to subscribe, in the database (1), for the provision of a given service (S), and to update and receive information relating to the said given service (S).

8. A system according to any one of claims 1 to 7, where the said user (U) is able, during a given period, to consume one or more given services (S) made available by one or more different service providers (P), characterised in that the management module (2) includes a sub-module (25) for centralising the services (S) consumed, allowing consolidation into a single bill of all or part of the services (S) consumed during the given period.

9. A system according to any one of claims 1 to 8, characterised in that the said management module (2) includes a sub-module (26) for payment of the crossover debts between several service providers (P).

10. A system according to any one of claims 1 to 9, characterised in that the said management module (2) includes a sub-module (27) for centralising payment incidents.

11. A system according to any one of claims 1 to 10, characterised in that the said management module (2) includes a sub-module (28) for centralising infringements and punishments, in particular allowing the prevention and management of repeat infringement.

12. A system according to any one of claims 1 to 11, characterised in that the management module (2) includes a means (29) for time and date stamping of the access by the user (U) to the service (S) of the service provider (P), and/or of the length of use of this said service (S).

13. A method for the interoperable management of multiple geolocatable services (S) proposed by service providers (P) and accessible to users (U) by toll charging, characterised in that it includes:
a stage for the transmission, by a transmission means (3) for regular or intermittent transmission of a user (U) location and identification data,
a stage for the reception, by a control means (21) for control of access by a user (U) to a service (S), of location and identification data of the said user (U)
a stage for comparison of the said location data of the said user (U) with the location data of the services (S) stored in a database (1), where the said database (1) also includes identification data for identification of a multiplicity of users (U), of a multiplicity of service providers (P), as well as access authorisation data for authorisation of access by the said users (U) to one or more of the said services (S),
if the said location data of the said user (U) coincide with the said location data of a service (S), a stage to control the authorisation of access by the said user (U) to the said service (S).

14. A method according to claims 13, characterised in that it includes a stage for billing the user (U) for its access to the service (S) of the service provider (P) and/or for the length of use of this said service (S).

15. A method according to any one of claims 13 and 14, characterised in that it includes a stage for the observation of infringements, when the stage to control the authorisation of access by the user (U) to the service (S) shows that the said user (U) is not registered in the database (1) for the said service (S) concerned, or that the right of the said user (U) to access the said service (S) is invalid.
